(19) United States
(12) Patent Application Publication
(10) Pub. No.: US 2024/0264570 A1
(43) Pub. Date: Aug. 8, 2024

(54) Automated Control Activation System with Machine Learning-Enabled Camera

(71) Applicant: International Business Machines Corporation, Armonk, NY (US)

(72) Inventors: Lamogha Chiazor, Eastleigh (GB); Tiberiu Suto, Franklin, NY (US); Rahul Jain, Kolkata (IN); Nelisa Delgado Van Slate, Mableton, GA (US); Amit Vachhani, Pune (IN)

(21) Appl. No.: 18/163,564

(22) Filed: Feb. 2, 2023

(51) Int. Cl. G05B 13/02

(52) U.S. Cl. CPC G05B 13/0265

(57) ABSTRACT

Changing state of an external system control is provided. An orientation of a control corresponding to an external system is identified utilizing a machine learning-enabled camera. An actuator head is moved to align with the orientation of the control corresponding to the external system utilizing the machine learning-enabled camera. A current state of the control corresponding to the external system is changed to a user-desired state utilizing the actuator head.

### BACKGROUND

### 1. Field

The disclosure relates generally to external systems and more specifically to an automated control activation system that includes a machine learning-enabled camera for directing an actuator head connected to an adjustable jointed arm to activate one or more controls corresponding to one or more external systems.

### 2. Description of the Related Art

A multitude of external systems (e.g., television systems, lighting systems, sound systems, climate control systems, door locking systems, security systems, appliance systems, machine systems, computer systems, and the like) have a set of controls, such as buttons, switches, or the like, to, for example, power on or power off a system or to enable the system to perform a set of activities, functions, operations, tasks, or the like. For example, a user typically controls operation of a television system (e.g., powers on, powers off, changes channel, and adjusts volume of the television system) using various buttons on a remote control device. A remote control device is an electronic device, which includes a plurality of different controls that a user utilizes to operate an external system from a distance, usually wirelessly. However, it should be noted that the controls can be located on the external system, itself, in addition to, or instead of, on a remote control device.

Generally, a user of an external system manually presses a control (e.g., a button) on the remote control device or on the external system, itself, each time the user wants to, for example, turn the system on or off, or enable the system to perform a particular activity, function, operation, or task. If the remote control device or external system is not currently within reach of the user, then the user needs to move to the location of the remote control device or the external system to manipulate a particular control to create a user-desired state in the external system.

### SUMMARY

According to one illustrative embodiment, a computer-implemented method for changing state of an external system control is provided. An automated control activation system, utilizing a machine learning-enabled camera, identifies an orientation of a control corresponding to an external system. The automated control activation system, utilizing the machine learning-enabled camera, moves an actuator head to align with the orientation of the control corresponding to the external system. The automated control activation system, utilizing the actuator head, changes a current state of the control corresponding to the external system to a user-desired state. According to other illustrative embodiments, an automated control activation system and computer program product for changing state of an external system control are provided.

### BRIEF DESCRIPTION OF THE DRAWINGS

FIG. 1 is a pictorial representation of a computing environment in which illustrative embodiments may be implemented;

FIG. 2 is a diagram illustrating an example of an external system control activation environment in accordance with an illustrative embodiment;

FIG. 3 is a flowchart illustrating a process for changing state of an external system control in accordance with an illustrative embodiment;

FIGS. 4A-4B are a flowchart illustrating a process for a stationary automated control activation system in accordance with an illustrative embodiment; and

FIGS. 5A-5C are a flowchart illustrating a process for a mobile automated control activation system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

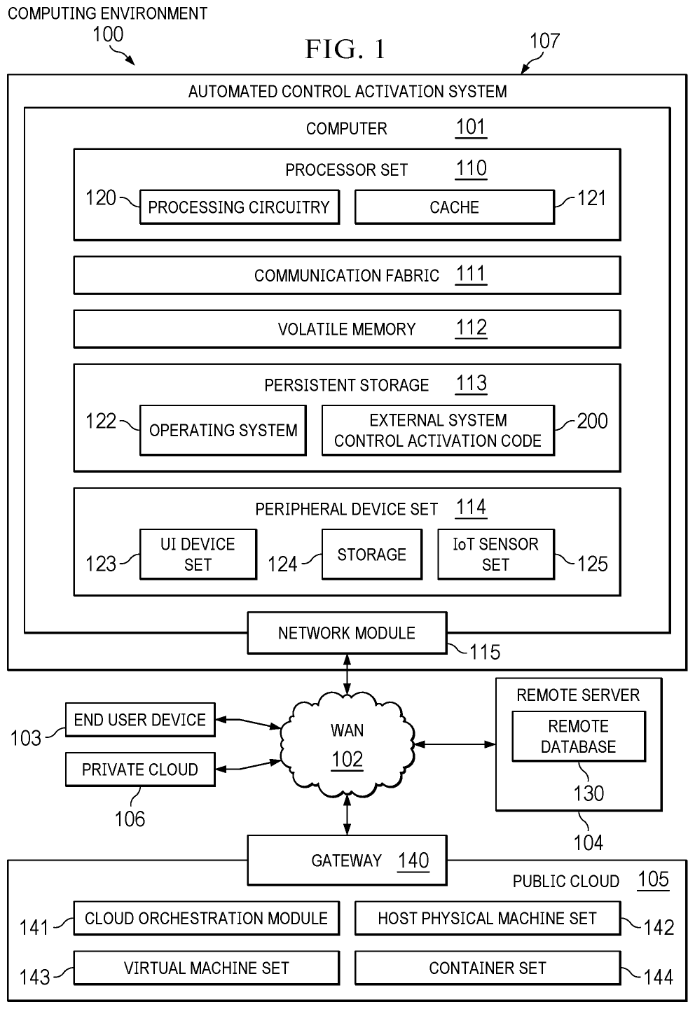

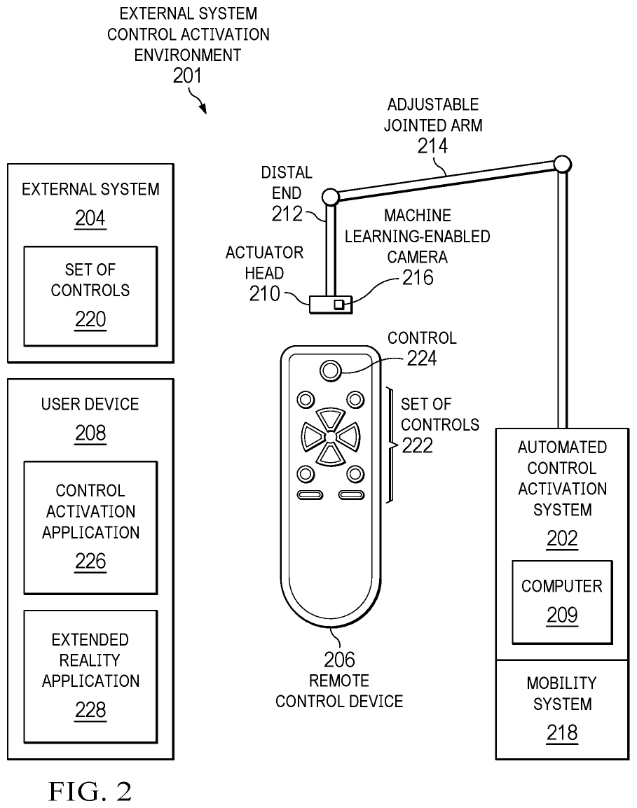

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as external system control activation code 200. External system control activation code 200 does not require controls of external systems to be in a specific location or in a particular orientation. In addition, external system control activation code 200 is capable of activating multiple controls on an external system without having a device (e.g., switch bot, add-on sticker, or the like) attached to the external system. External system control activation code 200 intelligently activates these multiple controls regardless of position and orientation on the external system or on a remote control device corresponding to the external system.

External system control activation code 200 utilizes a machine learning-enabled camera embedded in an actuator head of an adjustable jointed arm connected to automated control activation system 107. This machine learning-enabled camera acts similar to an edge device as the machine learning-enabled camera is capable of processing captured images near to the source of the images (e.g., the external system controls). For example, the machine learning-enabled camera utilizes an artificial neural network (e.g., artificial intelligence) trained with images of several different types of external system controls, such as, for example, different types of buttons, switches, and the like, which correspond to several different types of external systems in real-world environments. In addition, the images can be augmented with different transformations, such as, for example, different control orientations, skews, contrasts, saturations, and the like, so that the artificial neural network is capable of processing different images of the same type of control. Further, the artificial neural network is trained to differentiate between different states (e.g., an on state, an off state, an engaged state, a disengaged state, an enabled state, a disabled state, and the like) of a particular type of control in live mode. As a result, external system control activation code 200 increases the speed of response by automated control activation system 107, while maintaining precise activation of external system controls. Moreover, automated control activation system 107 can utilize a mobility system to travel to different locations or sites within an environment, which contains a plurality of external systems, to activate a group of controls corresponding to respective external systems. The mobility system may be comprised of, for example, motorized wheels, treads, rollers, legs, or the like.

Moreover, external system control activation code 200 enables a user to utilize an extended reality-enabled device (e.g., at least one of an augmented reality or mixed reality-enabled device) to control the activation of a set of controls corresponding to an external system and visualize the outcome of activating a particular control in real time, either in a real or virtual environment. Augmented reality and mixed reality also help the user to navigate large environments virtually and operate the set of controls of respective external systems in the real world remotely using a virtual object to interact with the real-world object (i.e., a control of the external system). External system control activation code 200 can activate multiple controls across multiple external systems with no configuration of any of the external systems that the user wants to manage or operate remotely.

In addition to external system control activation code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and external system control activation code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take any form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.”

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in external system control activation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The external system control activation code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks, such as the Internet. In various embodiments, UI device set 123 may include components such as a display screen, speaker, microphone, wearable devices (such as goggles and smart watches), keyboard, mouse, touchpad, and haptic devices. Storage 124 is external storage, such as an external hard drive, or insertable storage, such as an SD card. Storage 124 may be persistent and/or volatile. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of software, hardware, and firmware that allows automated control activation system 107 to communicate with other automated control activation systems, end user devices, computers, and the like via WAN 102. Network module 115 may include hardware, such as network adapter card or Wi-Fi signal transceiver, software for packetizing and/or de-packetizing data for communication network transmission, and/or web browser software for communicating data over the Internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 can be any type of computer system or mobile device that is used and controlled by an end user (for example, a user of automated control activation system 107). EUD 103 typically receives helpful and useful data from the operations of automated control activation system 107. For example, in a hypothetical case where automated control activation system 107 is designed to provide a recommendation to an end user, this recommendation would typically be communicated from network module 115 of automated control activation system 107 through WAN 102 to EUD 103. In this way, EUD 103 can display, or otherwise present, the recommendation to the end user. In some embodiments, EUD 103 may be a client device, such as thin client, heavy client, handheld computer, laptop computer, desktop computer, smartphone, smart glasses, and so on.

Remote server 104 is any computer system that serves at least some data and/or functionality to automated control activation system 107. Remote server 104 may be controlled and used by the same entity that provides or operates automated control activation system 107. Remote server 104 represents the machine(s) that collect and store helpful and useful data for use by other computers, such as computer 101. For example, in a hypothetical case where computer 101 is designed and programmed to provide a prediction based on historical data, then this historical data may be provided to computer 101 from remote database 130 of remote server 104.

Automated control activation system 107 may be located in a cloud environment, even though it is not shown in a cloud in FIG. 1. On the other hand, automated control activation system 107 is not required to be in a cloud except to any extent as may be affirmatively indicated.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Current devices, such as switch bots, which help a user resolve the issue of having to manually manipulate a control corresponding to an external system, lack the flexibility of using only one switch bot for multiple controls, without the user having to physically move the switch bot from one control to another. In other words, current solutions require the placement of a switch bot on each respective control that requires a button press action or placement of an add-on sticker on each respective control that requires an action to change the position of a switch.

Illustrative embodiments are capable of interacting with any external system, or any remote control device corresponding to an external system, which requires physical manipulation of controls to change state of a corresponding external system. Illustrative embodiments send a command signal to an actuator head, which is connected to a distal end of an adjustable jointed arm on an automated control activation system, to exert physical pressure on a particular control to change state or position of that particular control. Illustrative embodiments have the ability to move to each individual control on the external system, itself, or on the remote control device corresponding to the external system, by utilizing the machine learning-enabled camera, which is embedded in the actuator head of the automated control activation system and trained to differentiate between different types of controls and the different states of each different type of control.

Illustrative embodiments utilize the machine learning-enabled camera to detect and recognize a current state and orientation of a control and to automatically adjust the position of the actuator head accordingly to facilitate the physical manipulation of that particular control by the actuator head. Furthermore, illustrative embodiments can optionally integrate the automated control activation system with a mobility system to enable mobility of the automated control activation system within an environment containing a plurality of external systems needing remote operational control. Moreover, illustrative embodiments can utilize an extended reality device (e.g., an augmented reality device, a mixed reality device, or the like) to initiate operation of the automated control activation system.

Thus, illustrative embodiments ensure precise activation or manipulation of controls corresponding to respective external systems using the machine learning-enabled camera embedded in the actuator head, which is connected to the distal end of the adjustable jointed arm of the automated control activation system. Further, illustrative embodiments facilitate automatic activation of controls to a user-desired state or position without the user physically touching the controls. Because illustrative embodiments utilize the machine learning-enabled camera embedded in the actuator head of the automated control activation system, no need exists to place a switch bot or an add-on sticker on each respective control of an external system to manipulate the controls to change state or position.

By the user utilizing an extended reality-enabled device, such as, for example, a smartphone, smart glasses, smartwatch, smart headset, handheld computer, or the like, the user can activate multiple combinations of controls corresponding to different external systems, such as, for example, lighting systems, television systems, sound systems, climate control systems, door locking systems, security systems, appliance systems, machine systems, computer systems, and the like, in an environment to see the outcome in real time in a mixture of the real-world environment with a virtual environment (e.g., virtual or digital objects). The environment may be, for example, a house environment, apartment environment, office environment, machine shop environment, manufacturing environment, business environment, healthcare environment, educational environment, agricultural environment, or the like. Extended reality is an umbrella term that covers various technologies that include, for example, augmented reality, mixed reality, virtual reality, and the like. Augmented reality adds virtual objects to a live view by typically using a camera on a mobile device, such as, for example, a smartphone, smart glasses, a tablet computer, or the like. Mixed reality combines elements of both augmented reality and virtual reality to allow virtual objects to interact with real-world objects. Virtual reality implies a complete immersion experience that replaces the physical world with a virtual world. By utilizing illustrative embodiments with an extended reality-enabled device, the user can navigate any environment and operate any external system within that environment safely and efficiently.

Thus, illustrative embodiments provide one or more technical solutions that overcome a technical problem with remote activation of multiple external system controls without utilizing multiple devices, such as, switch bots, add-on stickers, or the like, attached to the controls. As a result, these one or more technical solutions provide a technical effect and practical application in the field of automated control of external systems.

With reference now to FIG. 2, a diagram illustrating an example of an external system control activation environment is depicted in accordance with an illustrative embodiment. External system control activation environment 201 may be implemented in a computing environment, such as computing environment 100 in FIG. 1. External system control activation environment 201 utilizes hardware and software components for remote activation of one or more controls corresponding to an external system by a user.

In this example, external system control activation environment 201 includes automated control activation system 202, external system 204, remote control device 206, and user device 208. Automated control activation system 202 may be, for example, automated control activation system 107 in FIG. 1. External system 204 may be, for example, a host physical machine of host physical machine set 142 in FIG. 1 or any other type of external system, such as a television system, lighting system, sound system, machine system, or the like. Remote control device 206 corresponds to external system 204 and is an optional device. In other words, external system 204 may not have a corresponding remote control device. User device 208 may be, for example, EUD 103 in FIG. 1. However, it should be noted that external system control activation environment 201 is intended as an example only and not as a limitation on illustrative embodiments. For example, external system control activation environment 201 can include any number of automated control activation systems, external systems, remote control devices, user devices, and other systems, devices, and components not shown.

In this example, automated control activation system 202 includes computer 209 and actuator head 210 at distal end 212 of adjustable jointed arm 214. Computer 209 may be, for example, computer 101 in FIG. 1. Automated control activation system 202 utilizes actuator head 210 to activate external system controls, such as, for example, buttons, switches, and the like. Automated control activation system 202 utilizes adjustable jointed arm 214 to move and position actuator head 210. Adjustable jointed arm 214 can include any number of movable joints and actuators, even though two movable joints are shown in this example. Actuator head 210 includes machine learning-enabled camera 216. Machine learning-enabled camera 216 is an image capturing device that utilizes a trained artificial neural network model to detect and recognize different types of external system controls and their orientation.

Automated control activation system 202 optionally includes mobility system 218. Mobility system 218 may include, for example, motorized wheels, treads, legs, or the like for moving across different types of surfaces within an environment.

External system 204 includes set of controls 220. Remote control device 206 includes set of controls 222. It should be noted that set of controls 222 corresponds to set of controls 220 included on external system 204.

In one illustrative embodiment, automated control activation system 202 is stationary (i.e., does not include mobility system 218). In this example, automated control activation system 202 utilizes adjustable jointed arm 214 to move actuator head 210 to a particular control (e.g., control 224 of set of controls 222 located on remote control device 206 to power on external system 204), which the user desires to activate. Actuator head 210 utilizes embedded machine learning-enabled camera 216 to detect and recognize control 224. In addition, actuator head 210 utilizes embedded machine learning-enabled camera 216 to detect and recognize in real time a current state of control 224 and its subsequent state after activation by actuator head 210.

In response to automated control activation system 202 receiving a command signal from user device 208 (e.g., a smartphone) via a network to activate control 224 remotely, machine learning-enabled camera 216 embedded in actuator head 210 orients and aligns actuator head 210 to activate control 224. The user of user device 208 utilizes control activation application 226, which is enabled on user device 208, to send the command signal to automated control activation system 202. In addition, machine learning-enabled camera 216 can optionally send an image of control 224 to user device 208 in order for the user to see in real time that control 224 is now changed to the user-desired state.

In an alternative illustrative embodiment, automated control activation system includes mobility system 218. Mobility system 218 enables automated control activation system 202 to travel from one place to another within the environment, which includes a plurality of external systems, to activate different controls corresponding to the plurality of external systems.

Further, the user of user device 208 can remotely activate or manipulate different controls of set of controls 222 or set of controls 220 using extended reality application 228, which also is enabled on user device 208. Extended reality application 228 includes at least one of an augmented reality application or a mixed reality application. Furthermore, the user of user device 208 can utilize extended reality application 228 to remotely activate or manipulate controls corresponding to different combinations of external systems in the environment and visualize the outcome of the different combinations in real time. For example, virtual objects overlapping the real-world objects in the environment can guide the user, who is utilizing extended reality application 228, to different controls corresponding to the different external systems within the environment. Once the user reaches the location of a particular control virtually within the environment, the user can then utilize control activation application 226 to send a command signal to automated control activation system 202 to activate that particular control. Alternatively, the user utilizing extended reality application 228 can interact with a virtual control object, which overlaps that particular control within the real-world environment. For example, the user can activate that particular control within the real-world environment by manipulating the virtual control object.

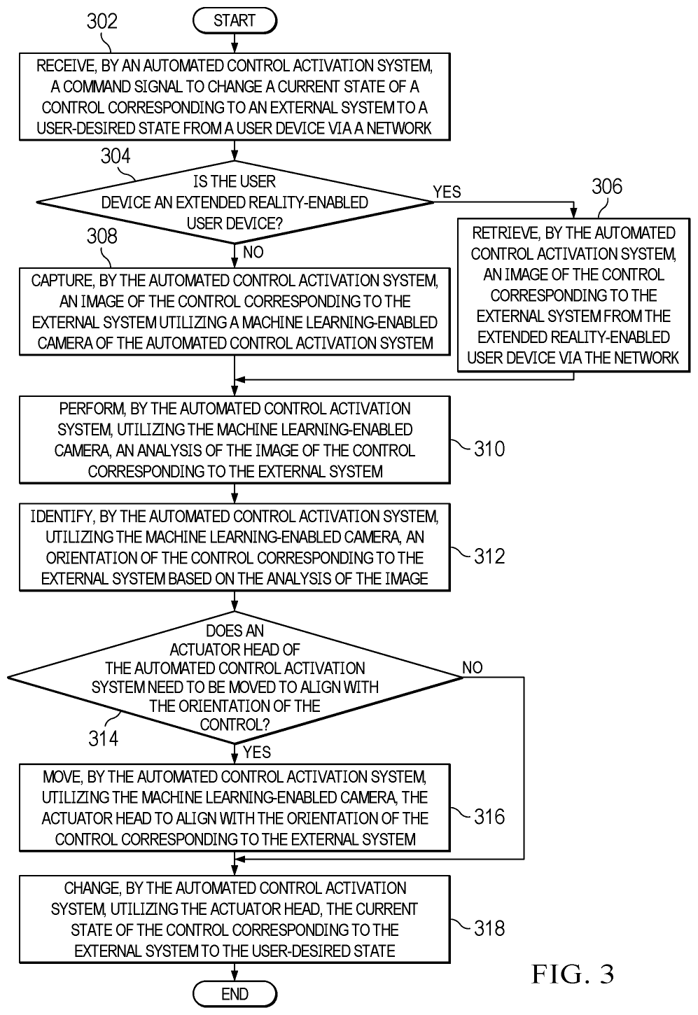

With reference now to FIG. 3, a flowchart illustrating a process for changing state of an external system control is shown in accordance with an illustrative embodiment. The process shown in FIG. 3 may be implemented in an automated control activation system, such as, for example, automated control activation system 107 in FIG. 1. For example, the process shown in FIG. 3 may be implemented in external system control activation code 200 in FIG. 1.

The process begins when the automated control activation system receives a command signal to change a current state of a control corresponding to an external system to a user-desired state from a user device via a network (step 302). The automated control activation system makes a determination as to whether the user device is an extended reality-enabled user device (step 304). If the automated control activation system determines that the user device is an extended reality-enabled user device, yes output of step 304, then the automated control activation system retrieves an image of the control corresponding to the external system from the extended reality-enabled user device via the network (step 306). Thereafter, the process proceeds to step 310. If the automated control activation system determines that the user device is not an extended reality-enabled user device, no output of step 304, then the automated control activation system captures an image of the control corresponding to the external system utilizing a machine learning-enabled camera of the automated control activation system (step 308).

The automated control activation system, utilizing the machine learning-enabled camera, performs an analysis of the image of the control corresponding to the external system (step 310). The automated control activation system, utilizing the machine learning-enabled camera, identifies an orientation of the control corresponding to the external system based on the analysis of the image (step 312).

The automated control activation system makes a determination as to whether an actuator head of the automated control activation system needs to be moved to align with the orientation of the control (step 314). If the automated control activation system determines that the actuator head of the automated control activation system does not need to be moved to align with the orientation of the control, no output of step 314, then the process proceeds to step 318. If the automated control activation system determines that the actuator head of the automated control activation system does need to be moved to align with the orientation of the control, yes output of step 314, then the automated control activation system, utilizing the machine learning-enabled camera, moves the actuator head to align with the orientation of the control corresponding to the external system (step 316). The automated control activation system, utilizing the actuator head, changes the current state of the control corresponding to the external system to the user-desired state (step 318). Thereafter, the process terminates.

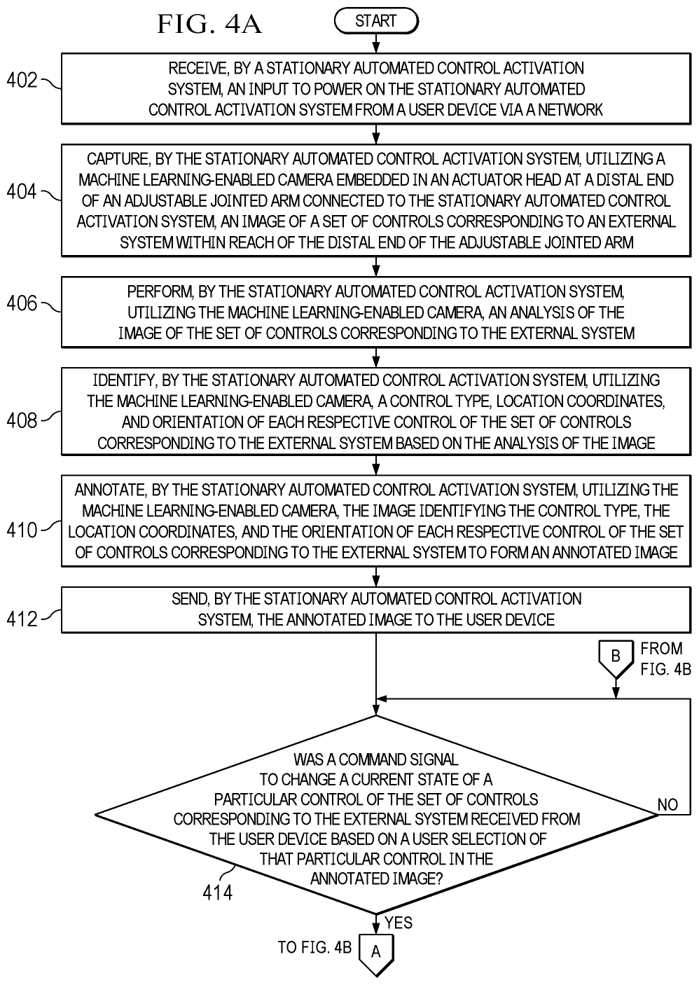

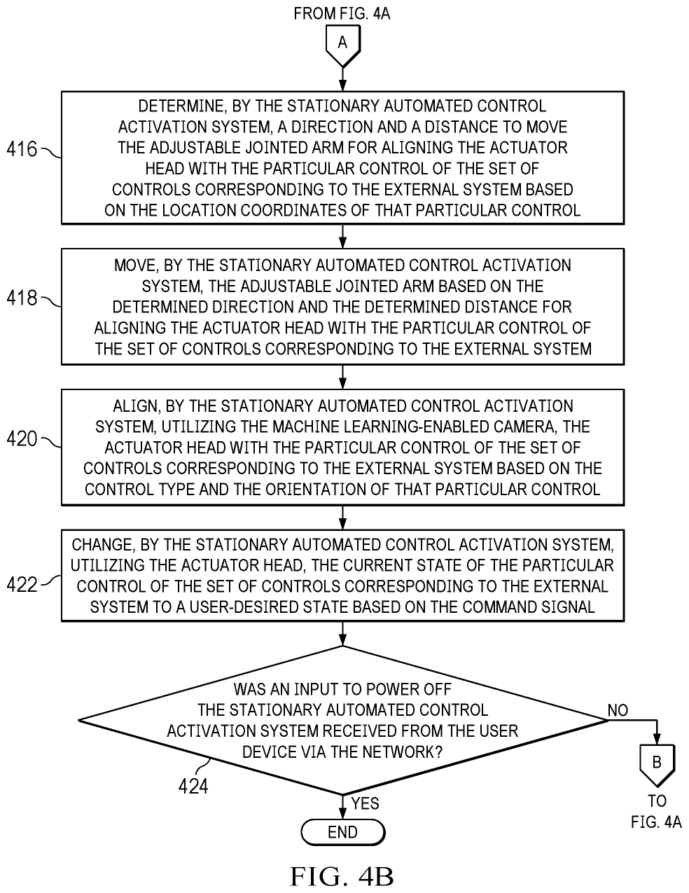

With reference now to FIGS. 4A-4B, a flowchart illustrating a process for a stationary automated control activation system is shown in accordance with an illustrative embodiment. The process shown in FIGS. 4A-4B may be implemented in an automated control activation system, such as, for example, automated control activation system 107 in FIG. 1. For example, the process shown in FIGS. 4A-4B may be implemented in external system control activation code 200 in FIG. 1.

The process begins when the stationary automated control activation system receives an input to power on the stationary automated control activation system from a user device via a network (step 402). The stationary automated control activation system, utilizing a machine learning-enabled camera embedded in an actuator head at a distal end of an adjustable jointed arm connected to the stationary automated control activation system, captures an image of a set of controls corresponding to an external system within reach of the distal end of the adjustable jointed arm (step 404). The stationary automated control activation system, utilizing the machine learning-enabled camera, performs an analysis of the image of the set of controls corresponding to the external system (step 406).

The stationary automated control activation system, utilizing the machine learning-enabled camera, identifies a control type, location coordinates, and orientation of each respective control of the set of controls corresponding to the external system based on the analysis of the image (step 408). The stationary automated control activation system, utilizing the machine learning-enabled camera, annotates the image identifying the control type, the location coordinates, and the orientation of each respective control of the set of controls corresponding to the external system to form an annotated image (step 410). The stationary automated control activation system sends the annotated image to the user device (step 412).

The stationary automated control activation system makes a determination as to whether a command signal to change a current state of a particular control of the set of controls corresponding to the external system was received from the user device based on a user selection of that particular control in the annotated image (step 414). If the stationary automated control activation system determines that a command signal to change the current state of the particular control of the set of controls corresponding to the external system was not received from the user device based on a user selection of that particular control in the annotated image, no output of step 414, then the process returns to step 414 where the stationary automated control activation system waits to receive a command signal. If the stationary automated control activation system determines that a command signal to change the current state of the particular control of the set of controls corresponding to the external system was received from the user device based on a user selection of that particular control in the annotated image, yes output of step 414, then the stationary automated control activation system determines a direction and a distance to move the adjustable jointed arm for aligning the actuator head with the particular control of the set of controls corresponding to the external system based on the location coordinates of that particular control (step 416).

The stationary automated control activation system moves the adjustable jointed arm based on the determined direction and the determined distance for aligning the actuator head with the particular control of the set of controls corresponding to the external system (step 418). The stationary automated control activation system, utilizing the machine learning-enabled camera, aligns the actuator head with the particular control of the set of controls corresponding to the external system based on the control type and the orientation of that particular control (step 420). The stationary automated control activation system, utilizing the actuator head, changes the current state of the particular control of the set of controls corresponding to the external system to a user-desired state based on the command signal (step 422).

The stationary automated control activation system makes a determination as to whether an input to power off the stationary automated control activation system was received from the user device via the network (step 424). If the stationary automated control activation system determines that an input to power off the stationary automated control activation system was not received from the user device via the network, no output of step 424, then the process returns to step 414 where the stationary automated control activation system waits to receive another command signal. If the stationary automated control activation system determines that an input to power off the stationary automated control activation system was received from the user device via the network, yes output of step 424, then the process terminates thereafter.

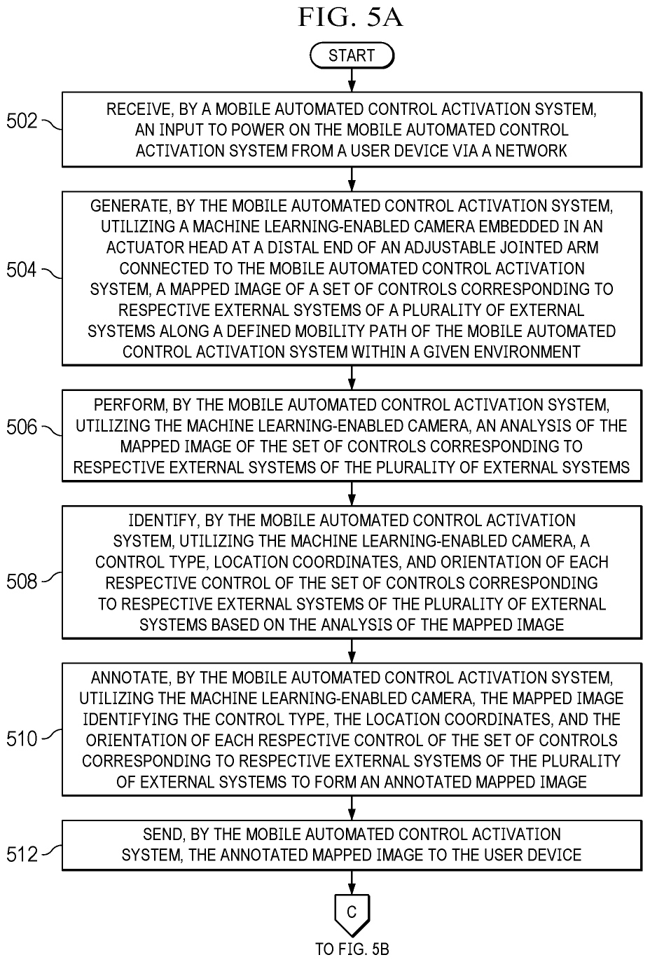

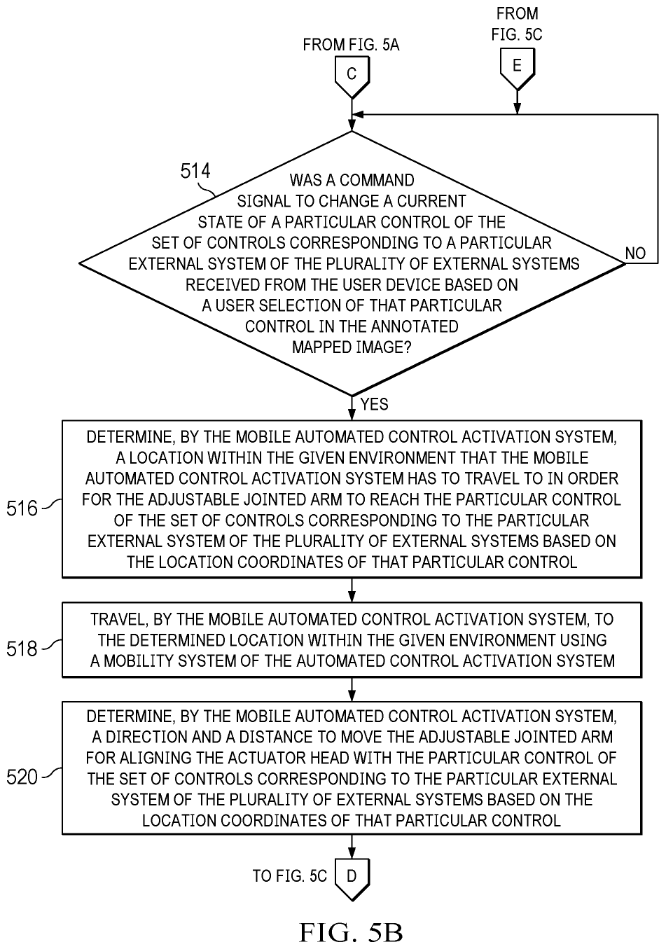

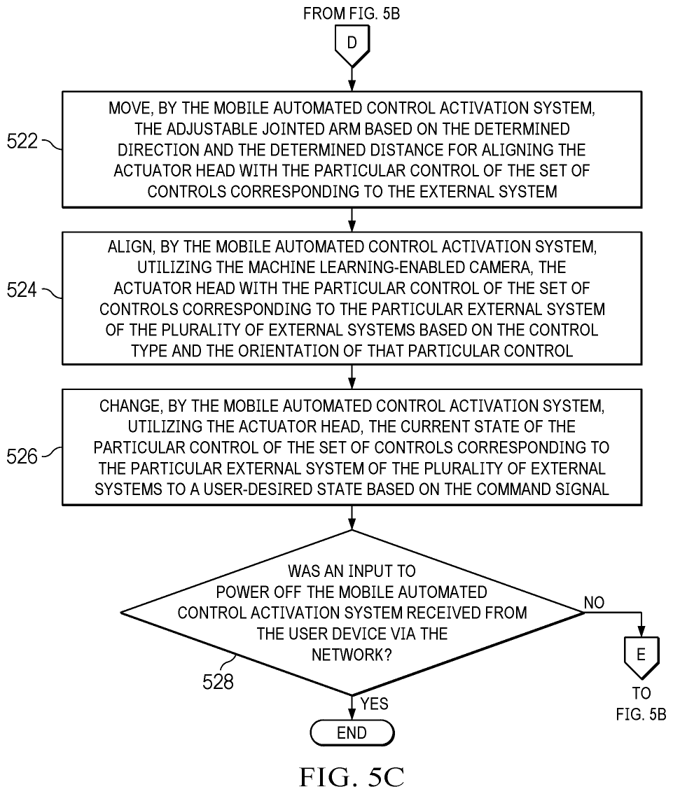

With reference now to FIGS. 5A-5C, a flowchart illustrating a process for a mobile automated control activation system is shown in accordance with an illustrative embodiment. The process shown in FIGS. 5A-5C may be implemented in an automated control activation system, such as, for example, automated control activation system 107 in FIG. 1. For example, the process shown in FIGS. 5A-5C may be implemented in external system control activation code 200 in FIG. 1.

The process begins when the mobile automated control activation system receives an input to power on the mobile automated control activation system from a user device via a network (step 502). The mobile automated control activation system, utilizing a machine learning-enabled camera embedded in an actuator head at a distal end of an adjustable jointed arm connected to the mobile automated control activation system, generates a mapped image of a set of controls corresponding to respective external systems of a plurality of external systems along a defined mobility path of the mobile automated control activation system within a given environment (step 504).

The mobile automated control activation system, utilizing the machine learning-enabled camera, performs an analysis of the mapped image of the set of controls corresponding to respective external systems of the plurality of external systems (step 506). The mobile automated control activation system, utilizing the machine learning-enabled camera, identifies a control type, location coordinates, and orientation of each respective control of the set of controls corresponding to respective external systems of the plurality of external systems based on the analysis of the mapped image (step 508). The mobile automated control activation system, utilizing the machine learning-enabled camera, annotates the mapped image identifying the control type, the location coordinates, and the orientation of each respective control of the set of controls corresponding to respective external systems of the plurality of external systems to form an annotated mapped image (step 510). The mobile automated control activation system sends the annotated mapped image to the user device (step 512).

The mobile automated control activation system makes a determination as to whether a command signal to change a current state of a particular control of the set of controls corresponding to a particular external system of the plurality of external systems was received from the user device based on a user selection of that particular control in the annotated mapped image (step 514). If the mobile automated control activation system determines that a command signal to change a current state of a particular control of the set of controls corresponding to a particular external system of the plurality of external systems was not received from the user device based on a user selection of that particular control in the annotated mapped image, no output of step 514, then the process returns to step 514 where the mobile automated control activation system waits to receive a command signal. If the mobile automated control activation system determines that a command signal to change a current state of a particular control of the set of controls corresponding to a particular external system of the plurality of external systems was received from the user device based on a user selection of that particular control in the annotated mapped image, yes output of step 514, then the mobile automated control activation system determines a location within the given environment that the mobile automated control activation system has to travel to in order for the adjustable jointed arm to reach the particular control of the set of controls corresponding to the particular external system of the plurality of external systems based on the location coordinates of that particular control (step 516).

The mobile automated control activation system travels to the determined location within the given environment using a mobility system of the automated control activation system (step 518). The mobile automated control activation system determines a direction and a distance to move the adjustable jointed arm for aligning the actuator head with the particular control of the set of controls corresponding to the particular external system of the plurality of external systems based on the location coordinates of that particular control (step 520). The mobile automated control activation system moves the adjustable jointed arm based on the determined direction and the determined distance for aligning the actuator head with the particular control of the set of controls corresponding to the external system (step 522).

The mobile automated control activation system, utilizing the machine learning-enabled camera, aligns the actuator head with the particular control of the set of controls corresponding to the particular external system of the plurality of external systems based on the control type and the orientation of that particular control (step 524). The mobile automated control activation system, utilizing the actuator head, changes the current state of the particular control of the set of controls corresponding to the particular external system of the plurality of external systems to a user-desired state based on the command signal (step 526).

The mobile automated control activation system makes a determination as to whether an input to power off the mobile automated control activation system was received from the user device via the network (step 528). If the mobile automated control activation system determines that an input to power off the mobile automated control activation system was not received from the user device via the network, no output of step 528, then the process returns to step 514 where the mobile automated control activation system waits to receive another command signal. If the mobile automated control activation system determines that an input to power off the mobile automated control activation system was received from the user device via the network, yes output of step 528, then the process terminates thereafter.

Thus, illustrative embodiments of the present invention provide a computer-implemented method, automated control activation system, and computer program product for changing state of external system controls remotely by a user. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for changing state of an external system control, the computer-implemented method comprising:
identifying, by an automated control activation system, utilizing a machine learning-enabled camera, an orientation of a control corresponding to an external system;
moving, by the automated control activation system, utilizing the machine learning-enabled camera, an actuator head to align with the orientation of the control corresponding to the external system; and
changing, by the automated control activation system, utilizing the actuator head, a current state of the control corresponding to the external system to a user-desired state.

2. The computer-implemented method of claim 1, further comprising:
receiving, by the automated control activation system, a command signal to change the current state of the control corresponding to the external system to the user-desired state from a user device via a network;
determining, by the automated control activation system, whether the user device is an extended reality-enabled user device; and
capturing, by the automated control activation system, an image of the control corresponding to the external system utilizing the machine learning-enabled camera of the automated control activation system in response to the automated control activation system determining that the user device is not an extended reality-enabled user device.

3. The computer-implemented method of claim 2, further comprising:
retrieving, by the automated control activation system, the image of the control corresponding to the external system from the extended reality-enabled user device via the network in response to the automated control activation system determining that the user device is an extended reality-enabled user device.

4. The computer-implemented method of claim 3, further comprising:
performing, by the automated control activation system, utilizing the machine learning-enabled camera, an analysis of the image of the control corresponding to the external system to identify the orientation of the control.

5. The computer-implemented method of claim 1, wherein the automated control activation system is a stationary automated control activation system, and further comprising:
capturing, by the stationary automated control activation system, utilizing the machine learning-enabled camera embedded in the actuator head at a distal end of an adjustable jointed arm connected to the stationary automated control activation system, an image of a set of controls corresponding to the external system within reach of the distal end of the adjustable jointed arm;
performing, by the stationary automated control activation system, utilizing the machine learning-enabled camera, an analysis of the image of the set of controls corresponding to the external system;
identifying, by the stationary automated control activation system, utilizing the machine learning-enabled camera, a control type, location coordinates, and orientation of each respective control of the set of controls corresponding to the external system based on the analysis of the image; and
annotating, by the stationary automated control activation system, utilizing the machine learning-enabled camera, the image identifying the control type, the location coordinates, and the orientation of each respective control of the set of controls corresponding to the external system.

6. The computer-implemented method of claim 5, further comprising:
determining, by the stationary automated control activation system, a direction and a distance to move the adjustable jointed arm for aligning the actuator head with a particular control of the set of controls corresponding to the external system based on the location coordinates of that particular control;
moving, by the stationary automated control activation system, the adjustable jointed arm based on the direction and the distance for aligning the actuator head with the particular control of the set of controls corresponding to the external system;
aligning, by the stationary automated control activation system, utilizing the machine learning-enabled camera, the actuator head with the particular control of the set of controls corresponding to the external system based on the control type and the orientation of that particular control; and
changing, by the stationary automated control activation system, utilizing the actuator head, the current state of the particular control of the set of controls corresponding to the external system to the user-desired state based on a received command signal.

7. The computer-implemented method of claim 1, wherein the automated control activation system is a mobile automated control activation system, and further comprising:
generating, by the mobile automated control activation system, utilizing the machine learning-enabled camera embedded in the actuator head at a distal end of an adjustable jointed arm connected to the mobile automated control activation system, a mapped image of a set of controls corresponding to respective external systems of a plurality of external systems along a defined mobility path of the mobile automated control activation system within a given environment;
performing, by the mobile automated control activation system, utilizing the machine learning-enabled camera, an analysis of the mapped image of the set of controls corresponding to respective external systems of the plurality of external systems;
identifying, by the mobile automated control activation system, utilizing the machine learning-enabled camera, a control type, location coordinates, and orientation of each respective control of the set of controls corresponding to respective external systems of the plurality of external systems based on the analysis of the mapped image; and
annotating, by the mobile automated control activation system, utilizing the machine learning-enabled camera, the mapped image identifying the control type, the location coordinates, and the orientation of each respective control of the set of controls corresponding to respective external systems of the plurality of external systems.

8. The computer-implemented method of claim 7, further comprising:
determining, by the mobile automated control activation system, a location within the given environment that the mobile automated control activation system has to travel to in order for the adjustable jointed arm to reach a particular control of the set of controls corresponding to a particular external system of the plurality of external systems based on the location coordinates of that particular control;
traveling, by the mobile automated control activation system, using a mobility system of the automated control activation system, to the location within the given environment;
determining, by the mobile automated control activation system, a direction and a distance to move the adjustable jointed arm for aligning the actuator head with the particular control of the set of controls corresponding to the particular external system of the plurality of external systems based on the location coordinates of that particular control;
moving, by the mobile automated control activation system, the adjustable jointed arm based on the direction and the distance for aligning the actuator head with the particular control of the set of controls corresponding to the external system;
aligning, by the mobile automated control activation system, utilizing the machine learning-enabled camera, the actuator head with the particular control of the set of controls corresponding to the particular external system of the plurality of external systems based on the control type and the orientation of that particular control; and
changing, by the mobile automated control activation system, utilizing the actuator head, the current state of the particular control of the set of controls corresponding to the particular external system of the plurality of external systems to the user-desired state based on a received command signal.

9. An automated control activation system for changing state of an external system control, the automated control activation system comprising:
a communication fabric;
a storage device connected to the communication fabric, wherein the storage device stores program instructions; and
a processor connected to the communication fabric, wherein the processor executes the program instructions to:
identify, utilizing a machine learning-enabled camera, an orientation of a control corresponding to an external system;
move, utilizing the machine learning-enabled camera, an actuator head to align with the orientation of the control corresponding to the external system; and
change, utilizing the actuator head, a current state of the control corresponding to the external system to a user-desired state.

10. The automated control activation system of claim 9, wherein the processor further executes the program instructions to:
receive a command signal to change the current state of the control corresponding to the external system to the user-desired state from a user device via a network;
determine whether the user device is an extended reality-enabled user device; and
capture an image of the control corresponding to the external system utilizing the machine learning-enabled camera of the automated control activation system in response to determining that the user device is not an extended reality-enabled user device.

11. The automated control activation system of claim 10, wherein the processor further executes the program instructions to:
retrieve the image of the control corresponding to the external system from the extended reality-enabled user device via the network in response to determining that the user device is the extended reality-enabled user device.

12. The automated control activation system of claim 11, wherein the processor further executes the program instructions to:
perform, utilizing the machine learning-enabled camera, an analysis of the image of the control corresponding to the external system to identify the orientation of the control.

13. A computer program product for changing state of an external system control, the computer program product comprising a computer-readable storage medium having program instructions embodied therewith, the program instructions executable by a computer of an automated control activation system to cause the automated control activation system to perform a method of:
identifying, by the automated control activation system, utilizing a machine learning-enabled camera, an orientation of a control corresponding to an external system;
moving, by the automated control activation system, utilizing the machine learning-enabled camera, an actuator head to align with the orientation of the control corresponding to the external system; and
changing, by the automated control activation system, utilizing the actuator head, a current state of the control corresponding to the external system to a user-desired state.

14. The computer program product of claim 13, further comprising:
receiving, by the automated control activation system, a command signal to change the current state of the control corresponding to the external system to the user-desired state from a user device via a network;
determining, by the automated control activation system, whether the user device is an extended reality-enabled user device; and
capturing, by the automated control activation system, an image of the control corresponding to the external system utilizing the machine learning-enabled camera of the automated control activation system in response to the automated control activation system determining that the user device is not an extended reality-enabled user device.

15. The computer program product of claim 14, further comprising:
retrieving, by the automated control activation system, the image of the control corresponding to the external system from the extended reality-enabled user device via the network in response to the automated control activation system determining that the user device is an extended reality-enabled user device.

16. The computer program product of claim 15, further comprising:
performing, by the automated control activation system, utilizing the machine learning-enabled camera, an analysis of the image of the control corresponding to the external system to identify the orientation of the control.

17. The computer program product of claim 13, wherein the automated control activation system is a stationary automated control activation system, and further comprising:
capturing, by the stationary automated control activation system, utilizing the machine learning-enabled camera embedded in the actuator head at a distal end of an adjustable jointed arm connected to the stationary automated control activation system, an image of a set of controls corresponding to the external system within reach of the distal end of the adjustable jointed arm;
performing, by the stationary automated control activation system, utilizing the machine learning-enabled camera, an analysis of the image of the set of controls corresponding to the external system;
identifying, by the stationary automated control activation system, utilizing the machine learning-enabled camera, a control type, location coordinates, and orientation of each respective control of the set of controls corresponding to the external system based on the analysis of the image; and
annotating, by the stationary automated control activation system, utilizing the machine learning-enabled camera, the image identifying the control type, the location coordinates, and the orientation of each respective control of the set of controls corresponding to the external system.

18. The computer program product of claim 17, further comprising:
determining, by the stationary automated control activation system, a direction and a distance to move the adjustable jointed arm for aligning the actuator head with a particular control of the set of controls corresponding to the external system based on the location coordinates of that particular control;
moving, by the stationary automated control activation system, the adjustable jointed arm based on the direction and the distance for aligning the actuator head with the particular control of the set of controls corresponding to the external system;
aligning, by the stationary automated control activation system, utilizing the machine learning-enabled camera, the actuator head with the particular control of the set of controls corresponding to the external system based on the control type and the orientation of that particular control; and
changing, by the stationary automated control activation system, utilizing the actuator head, the current state of the particular control of the set of controls corresponding to the external system to the user-desired state based on a received command signal.

19. The computer program product of claim 13, wherein the automated control activation system is a mobile automated control activation system, and further comprising:
generating, by the mobile automated control activation system, utilizing the machine learning-enabled camera embedded in the actuator head at a distal end of an adjustable jointed arm connected to the mobile automated control activation system, a mapped image of a set of controls corresponding to respective external systems of a plurality of external systems along a defined mobility path of the mobile automated control activation system within a given environment;
performing, by the mobile automated control activation system, utilizing the machine learning-enabled camera, an analysis of the mapped image of the set of controls corresponding to respective external systems of the plurality of external systems;
identifying, by the mobile automated control activation system, utilizing the machine learning-enabled camera, a control type, location coordinates, and orientation of each respective control of the set of controls corresponding to respective external systems of the plurality of external systems based on the analysis of the mapped image; and
annotating, by the mobile automated control activation system, utilizing the machine learning-enabled camera, the mapped image identifying the control type, the location coordinates, and the orientation of each respective control of the set of controls corresponding to respective external systems of the plurality of external systems.

20. The computer program product of claim 19, further comprising:
determining, by the mobile automated control activation system, a location within the given environment that the mobile automated control activation system has to travel to in order for the adjustable jointed arm to reach a particular control of the set of controls corresponding to a particular external system of the plurality of external systems based on the location coordinates of that particular control;
traveling, by the mobile automated control activation system, using a mobility system of the automated control activation system, to the location within the given environment;
determining, by the mobile automated control activation system, a direction and a distance to move the adjustable jointed arm for aligning the actuator head with the particular control of the set of controls corresponding to the particular external system of the plurality of external systems based on the location coordinates of that particular control;
moving, by the mobile automated control activation system, the adjustable jointed arm based on the direction and the distance for aligning the actuator head with the particular control of the set of controls corresponding to the external system;
aligning, by the mobile automated control activation system, utilizing the machine learning-enabled camera, the actuator head with the particular control of the set of controls corresponding to the particular external system of the plurality of external systems based on the control type and the orientation of that particular control; and
changing, by the mobile automated control activation system, utilizing the actuator head, the current state of the particular control of the set of controls corresponding to the particular external system of the plurality of external systems to the user-desired state based on a received command signal.
